(19) United States
(12) Patent Application Publication
(10) Pub. No.: US 2006/0012693 A1
(43) Pub. Date: Jan. 19, 2006

(54) Imaging process system, program and memory medium

(76) Inventor: Masao Sambongi, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 11/146,307

(22) Filed: Jun. 6, 2005

(30) Foreign Application Priority Data
Jun. 8, 2004 (JP) 169359/2004

(51) Int. Cl. H04N 5/217

(52) U.S. Cl. 348/241

(57) ABSTRACT

A predetermined subject is obtained from a image signal constituted by pixel signals obtained from an imaging device. Noise contained in image signal is reduced according to the obtained subject scene data. Imaging device noise stemming from the imaging device is estimated from the image signal and the imaging device noise is reduced according to the estimated imaging device noise.

### BACKGROUND OF INVENTION

The present invention relates to noise reducing systems for imaging device systems and, more particularly, to imaging process system, program and storing medium permitting noise reduction optimized for each subject scene.

Digitalized signals obtained from analog circuits and A/D converters included in imaging devices contain noise components. Such noise components can be classified into fixed noises and random noises. Fixed noises are mainly generated in imaging devices, typically defective pixels. Random noises are generated in imaging devices and analog circuits, and have characteristics close to white noise characteristics. As means for suppressing random noises, Literate 1 (Japanese patent Laid-open 2001-157057) discloses a method, in which noise quantities are expressed in the form of functions with respect to signal levels, a noise quantity corresponding to a signal level is estimated from such functions, and the frequency characteristic of filtering is controlled according to the noise quantity.

Literature 2 (Japanese patent Laid-open Hei 8-77350), on the other hand, an image processing system, which comprises a noise removing/edge emphasizing means for inputting image data of a predetermined filter area to a low- and a high-pass filter, separately and removing noise in the high-pass filter output while executing edge emphasis, and a combining circuit for combining the low-pass filter output and the noise removing/edge emphasizing means output. The noise removing/edge emphasizing means is constituted by a plurality of selectively used look-up tables, and a look-up table selectively used in the noise removing/edge emphasizing means is determined according to the density difference between the density of a noted pixel and the density obtained with respect to the filter area of the noted pixel.

However, even where a noise reducing process is executed according to the noise quantity, a flat subject scene such as a skin and a subject scene having a texture structure are given different subjective evaluations. That is, the above prior technique has a problem that it is impossible to cope with the differences of the condition and subject when taking a picture. Another problem presented is that it is impossible to cope with the difference of the subject such as skin and sky only in the distinction between character and picture.

### SUMMARY OF INVENTION

An object of the present invention, accordingly, is to provide imaging process system, program and storing medium, for executing subjective noise estimation not only from the signal level but also from the subject scene data, thus permitting subjectively preferred noise reducing process.

Another object of the present invention is to provide imaging process system, program an storing medium, for executing a noise reducing process for reducing noise caused by the imaging device system and also a subjective noise reducing process for obtaining subjectively high quality images.

A further object of the present invention is to provide imaging process system, program and storing medium, for executing noise reduction optimized for each subject scene according to the quantity of generated noise and estimation of the subject scene.

According to a first aspect of the present invention, there is provided an imaging process system for obtaining subject scene data of a predetermined subject from a image signal constituted by pixel signals obtained from an imaging device and reducing noise contained in image signal according to the obtained subject scene data.

According to a second aspect of the present invention, there is provided an imaging process system for obtaining subject scene data of a predetermined subject from a image signal constituted by pixel signals obtained from an imaging device and reducing noise contained in the image signal according to the obtained subject scene data, while estimating imaging device noise caused by the imaging device from the image signal and reducing the imaging device noise according to the estimated imaging device noise.

Predetermined subjective noise contained in the subject scene image signal is estimated according to the subject scene image, and the noise reducing process is executed according to the estimated noise. The subject scene data is obtained according to a local area signal as a small aggregate of pixel signals. A standard deviation of the local area is obtained, and the noise reducing process is executed according to the obtained standard deviation and the subjective noise. A smoothing process is executed when a standard deviation of the local area is less than the estimated subjective noise quantity.

In the subjective noise estimation the pixel signals are sorted according to predetermined colors, and the subject scene data is obtained according to sorted areas. The relationship of area data and average value of the subject scene data and subjective noise quantity is preliminarily stored in a ROM and the subjective noise is obtained with reference to the ROM according to the obtained area data and the average value of the subject scene. The subject scene data is obtained in a pattern matching process of comparing a preliminarily prepared pattern of pixel signals for a predetermined area and a pattern of the pixel signals obtained from the image signal for a predetermined area.

Frequency data of the image signal is obtained, and the subject scene data is obtained according to the frequency data. Parameters for a filtering process for executing the noise reducing process is preliminarily stored in a ROM, and the filtering process is executed with parameters read out from the ROM according to the subject scene data. The imaging device noise reducing process is executed prior to the subjective noise reducing process.

According to a third aspect of the present invention, there is provided an imaging process system for estimating imaging device noise caused by the imaging device from a image signal constituted by pixel signals obtained from the imaging device, estimating predetermined subjective noise from the image signal, compensating for imaging device noise according to the estimated subjective noise and reducing the image signal noise according to the compensated noise.

According to a fourth aspect of the present invention, there is provided an imaging process method comprising: a first step of inputting header data containing ISO sensitivity and image size data and an image signal constituted by pixel signals from an imaging device; a second step of executing a white balance process, a color conversion process, etc. on the image signal; a third step of estimating a predetermined subjective noise quantity according to an image signal obtained after the process in the second step; and a fourth step of executing a subjective noise reducing process according to the estimated subjective noise quantity.

According to a fifth aspect of the present invention, there is provided an imaging process method comprising: a first step of inputting header data containing ISO sensitivity and image size data and an image signal constituted by pixel signals from an imaging device; a second step of reading out an image signal of predetermined areas centered on noted pixels; a third step of estimating imaging device noise for each noted pixel unit; a fourth step of executing an imaging device noise reducing process according to the estimated imaging device noise for each noted pixel unit; a fifth step of executing the processes of the above steps on all pixels; a sixth step of executing a white balance process, a color conversion process, etc. after the first to fifth steps on all the pixels; a seventh step of estimating predetermined subjective noise on the image signal; and an eighth step of executing a subjective noise reducing process for each noted pixel unit according to the estimated subjective noise.

According to a sixth aspect of the present invention, there is provided an imaging process system for reducing noise contained in a digitalized image signal from an imaging device, comprising: a subjective noise estimating means for estimating a predetermined noise quantity in the signal; and a subjective noise reducing means for reducing subjective noise in the signal according to the subjective noise quantity.

According to a seventh aspect of the present invention, there is provided an imaging process system for reducing noise contained in a digitalized image signal from an imaging device, comprising: an imaging device noise estimating means for estimating an imaging device noise quantity in the signal; an imaging device noise reducing means for reducing imaging device noise in the signal according to the imaging device noise quantity; a subjective noise estimating means for estimating predetermined subjective noise quantity of a subject scene in the signal; and a subjective noise reducing means for reducing subjective noise in the signal according to the subjective noise quantity.

According to an eighth aspect of the present invention, there is provided an imaging process system for reducing noise contained in a digitalized image signal from an imaging device, comprising: an imaging device estimating means for estimating an imaging device noise quantity in the signal; a subjective noise estimating means for estimating a predetermined subjective noise quantity of a subject scene in the signal; a compensating means for compensating for the imaging device noise quantity according to data obtained from the subjective noise estimating means; and a noise reducing means for noise in the signal according to the compensated noise quantity.

The subjective noise estimating means includes: a particular color extracting means for extracting a particular color in the signal; an image dividing means for dividing the image according to the particular color data; a subject scene recognizing means for recognizing subject scene data of the area divisions; and a subjective noise calculating means for estimating subjective noise quantity of the subject scene in the signal.

The subjective noise estimating means includes: a pattern data calculating means for calculating pattern data in the signal; an image dividing means for dividing image according to the pattern data; a subject scene recognizing means for recognizing subject scene data of the area divisions; and a subjective noise calculating means for estimating a subjective noise quantity of subject scene in the image.

Here, there are provided a computer program for executing the above processes and a storing medium, in which the computer program is stored.

### BRIEF DESCRIPTION OF DRAWINGS

FIG. 1 is a block diagram showing a first embodiment of the imaging process system according to the present invention;

FIG. 2 is a block diagram showing a first example of the subjective noise estimating unit according to the present invention;

FIGS. 3A and 3B are drawing for explaining image region division according to the embodiment of the present invention;

FIG. 4 is a view for describing an image area division pattern used for recognizing the subject scene;

FIG. 5 is a view for describing function data stored in the parameter ROM 619 to be used for subjective noise quantity calculation;

FIG. 6 is a block diagram showing a second example of the subjective noise estimating unit according to the present invention;

FIG. 7 is a block diagram showing a third example of the subjective noise estimating unit according to the present invention;

FIG. 8 is a block diagram showing a fourth example of the subjective noise estimating unit according to the present invention;

FIG. 9 is a block diagram showing an example of the subjective noise reducing unit according to the present invention;

FIG. 10 shows a flow chart representing the software process routine in the first embodiment;

FIG. 11 is a block diagram showing a second embodiment of the imaging process system according to the present invention;

FIG. 12 shows an arrangement example of the imaging device noise estimating unit according to the present invention;

FIG. 13 is a view for describing the function of imaging device noise quantity according to the present invention;

FIG. 14 is a flow chart showing the software process routine in the second embodiment;

FIG. 15 is a block diagram showing a third embodiment of the imaging process system according to the present invention; and

FIG. 16 is a flow chart showing a software process routine in the third embodiment;

### PREFERRED EMBODIMENTS OF INVENTION

Embodiments of imaging process system, program and storing medium according to the present invention will be described with reference to attached drawings.

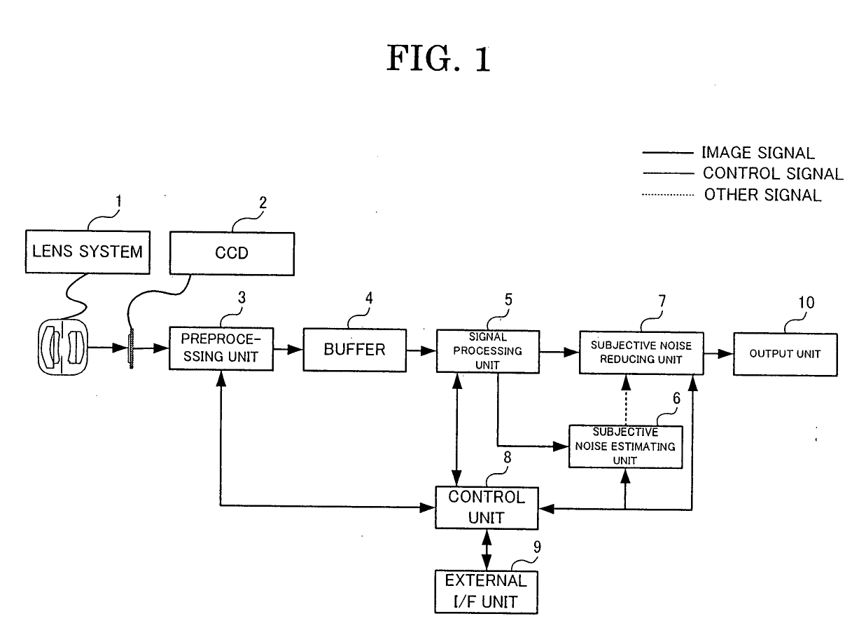

FIG. 1 is a block diagram showing a first embodiment of the imaging process system according to the present invention.

Referring to FIG. 1, imaging conditions such as ISO sensitivity are inputted via an external I/F unit 9 to and set in a control unit 8, which controls the entire system. Then, in response to the push of a shutter button, image signal is read out. The image signal is obtained by imaging a scene via a lens system 1 and a CCD 2 and converting the obtained signal to-electric signal. A preprocessing unit 3 executes such preprocesses as gain amplification, A/D conversion and AF and AE controls on the image signal, and transfers the preprocessed signal to a buffer 4. Signal read out from the buffer 4 is transferred to a signal processing unit 5.

Under control of the control unit 8, the signal processing unit 5 executes well-known white balance and color conversion processes on the image signal transferred from the buffer 4, and transfers the results of the processes to a subjective noise estimating unit 6 and a subjective noise reducing unit 7.

Under control of the control unit 8, the subjective noise estimating unit 6 extracts, local areas centered on noted pixels in the image signal transferred from the signal processing unit 5, and estimates subjective noise and also subject scene. The unit 6 transfers data of the estimated subjective noise quantity and subject scene to the subjective noise reducing unit 7. The unit 6 further calculates a standard deviation as local area noise quantity, and transfers the calculated standard deviation to the subjective noise reducing unit 7.

Under control of the control unit 8, the subjective noise reducing unit 7 executes a process of reducing subjective noise in the local area. In this subjective noise reducing process, the unit 7 compares the local area standard deviation transferred from the subjective noise estimating unit 6 and the estimated subjective noise quantity. When the local area standard deviation is less than the estimated subjective noise quantity, the unit 7 executes a well-known smoothing process in the local area, thus updating the value of the noted pixel. When the local area standard deviation is greater than the estimated subjective noise quantity, the unit 7 executes no process.

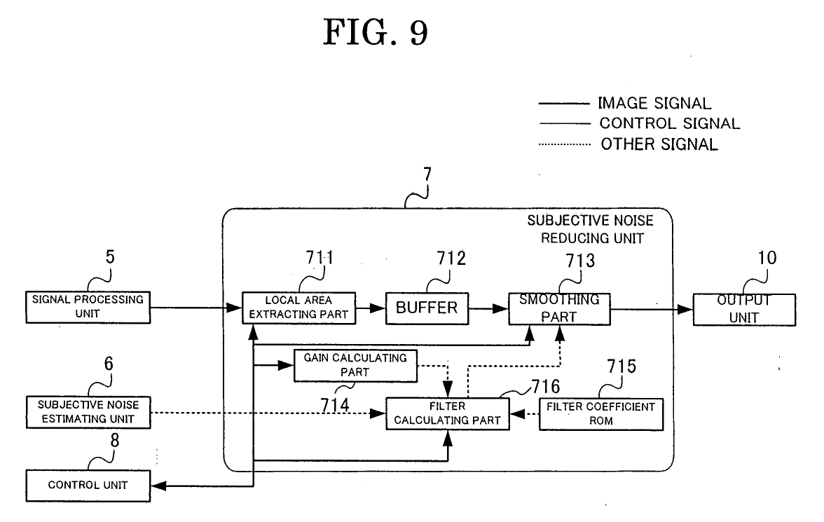

As described above, in this embodiment, the subjective noise estimating unit 6 executes estimation of the subjective noise, and according to the estimated data the subjective noise reducing unit 7 executes reduction of the subjective noise in the image. Thus, it is possible to obtain subjectively preferred, high quality images. The subjective noise reducing process is, for example, a filter process as shown in FIG. 9 to be described later in details is executed.

The subjective noise reducing unit 7 executes the subjective noise reducing process with respect to all noted pixels, and transfers the image signal after the subjective noise reducing process to the output unit 10. In the output unit 10, the image signal is recorded and stored in a memory card.

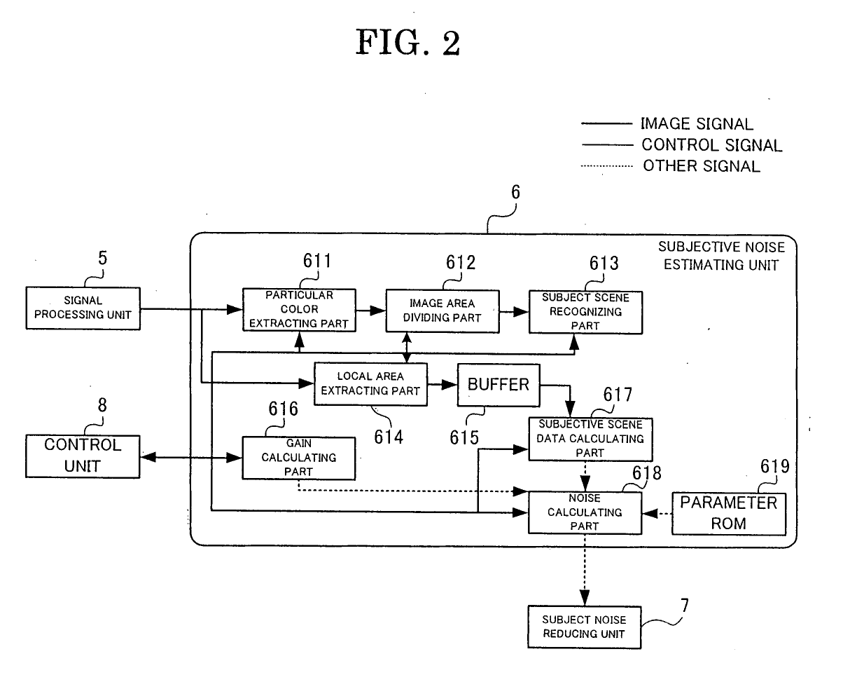

FIG. 2 is a block diagram showing a first example of the subjective noise estimating unit 6 shown in FIG. 1. This example includes a particular color extracting part 611, an image area dividing part 612, a subject scene recognizing part 613, a local area extracting part 614, a buffer 615, a gain calculating part 616, a subjective scene data calculating part 617, a noise calculating part 618 and a parameter ROM 619.

Under control of the control unit 8, the gain calculating part 616 obtains the amplification factor of gain amplification obtained in a process executed in the preprocessing unit 3 according to the ISO sensitivity set via the external I/F unit 9, and transfers the amplification factor to the noise calculating part 618

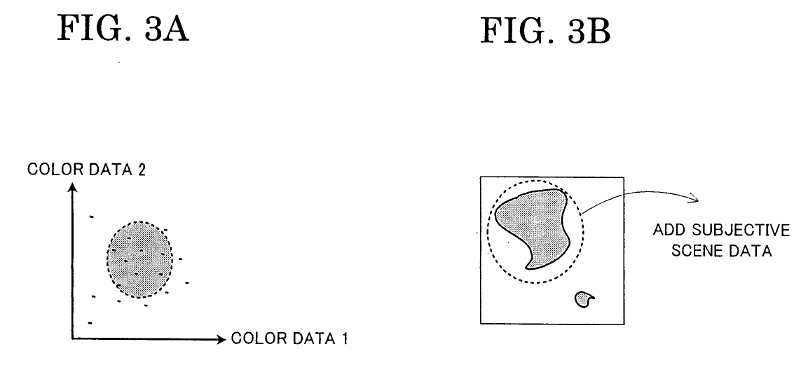

Under control of the control unit 8, the particular color extracting part 611 reads out the image signal transferred from the signal processing unit 5 pixel by pixel, and maps the read-out image signal in a color space as shown in FIG. 3(a). After executing this process with respect to all the pixels, the particular color extracting part 611 extracts pixels contained in a particular color area preliminarily designated in the color space. In FIG. 3(a), the shaded part enclosed in the dashed loop corresponds to the particular color area. Conceivable particular colors are skin color, blue color, green color, etc. It is assumed that in the signal processing unit 5 the image signal has been converted to color signal of RGB, L*a*b*, etc.

Under control of the control unit 8, the image area dividing part 612 maps the pixels extracted as particular color in a real space as shown in FIG. 3 (b). After this process has been executed with respect to all the pixels extracted as particular color, the image area dividing part 612 extracts, as subject scene, the aggregate of pixels having areas more than a predetermined area in the real space. In FIG. 3(b), the area enclosed in the dashed loop corresponds to the extracted subject scene.

Under control of the control unit 8, the subject scene recognizing part 613 recognizes the subject scene extracted in the image area dividing part 612.

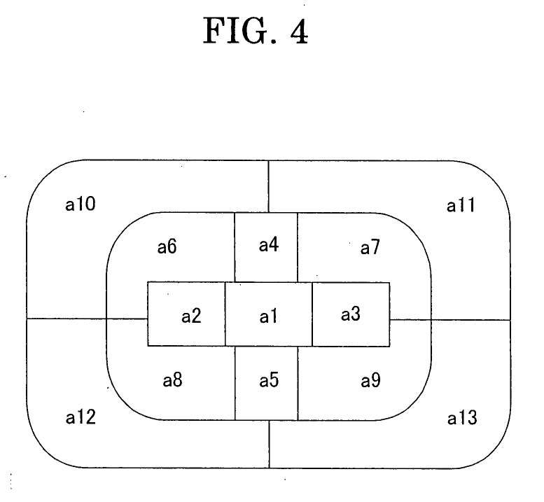

FIG. 4 is a view for describing an image area division pattern used for recognizing the subject scene. In the case of a subject scene present in an area a10 or all and in blue in color, the subject scene recognizing part 613 recognizes the scene to be sky. In the case of a subject scene present in an area a12 or a13, the part 613 recognizes the scene to be sea. In the case of a subject scene in an area a4, a6 or a7 and skin in color, the part 613 recognizes the scene to be a face. In the case of a subject scene in an area a4, a6, a7, a10 or all and green in color, the part 613 recognizes the scene to be a tree. In the case of a subject scene in an area a5, a8, a9, a12 or a13, the part 613 recognizes the scene to be turf or grass.

As a result of the process executed in it, the subject scene recognizing part 613 labels all the pixels extracted as subject scene in such a manner that the subject scene is “1” when the scene is sky and “2” when the scene is a face. In the process executed in the particular color extracting part 611 up to the subject scene recognizing part 613, the pixels which are not recognized as subject scene are made to be “0” in label. In this way, the subject scene recognizing part 613 labels all the pixels in the above process, and transfers the labeled pixel data to the subject scene data calculating part 617.

Under control of the control unit 8, the local area extracting part 614 extracts areas of a predetermined size, for instance local areas in units of 5×5 pixels, centered on noted pixels of the image signal transferred from the signal processing unit 5, and transfers the local area data to the buffer 615.

The subject scene data calculating part 617 calculates subject scene data, for instance the subject scene area, according to the local area signal transferred from the buffer 615 and the labeled pixels transferred from the subject scene recognizing part 613. The part 617 executes the area calculation as follows. The part 617 calculates the number ai (i being a natural number) of pixels of label “i”, and makes the quotient ai/T of division of the number ai by the total pixel number T of the entire image to be the subject scene area. The unit 617 executes like processes with respect to all the labels, and transfers data of the areas of these labels to the noise calculating part 618.

In the case of other label data than “0” of the noted pixels transferred from the subject scene recognizing part 613 with respect to signals of local areas centered on the noted pixels transferred from the buffer 615, the subject scene data calculating part 617 calculates, with respect to the pixels recognized as subject scene, the average and variance (standard deviation) of the local areas centered on the noted pixels, and transfers the calculated data to the noise calculating part 618.

Under control of the control unit 8, the noise calculating part 618 obtains, from the parameter ROM 619, function data used for subjective noise quantity calculation to be described later according to amplification factor from the gain calculating part 616 and label data and subject scene area data from the subject scene data calculating part 617. The part 618 executes the subjective noise calculation with reference to, for instance, gray chart noise quantity, and shows to the tested person a chart of particular colors such as skin color having the same noise quantity as the reference and the actual image of sky, sea, etc. by changing the luminance and area. The tested person conducts a subjective evaluation experiment, then he or she compares the resultant calculated evaluation value and a gray chart evaluation value to calculate how many times the gray chart noise quantity is the noise quantity of a particular color sensed by him or her, and makes the result to be the subjective noise quantity.

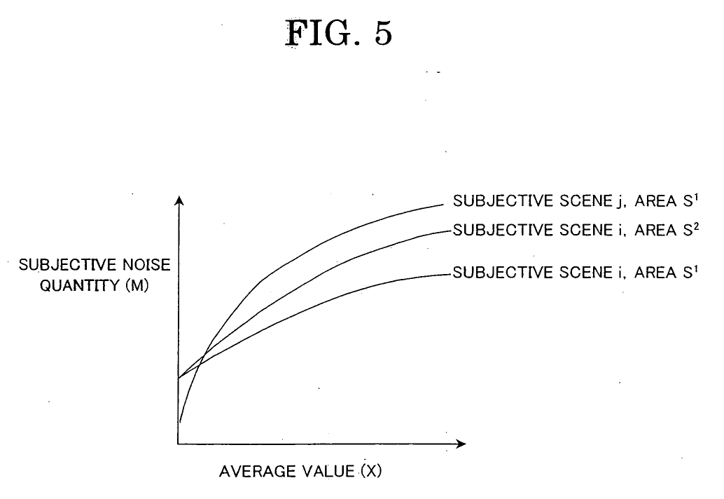

FIG. 5 is a view for describing function data stored in the parameter ROM 619 to be used for subjective noise quantity calculation. As shown in the Figure, these functions have shapes determined by the label data and area of the subject scene, and the subjective noise quantity varies with the average value X of the local area. As described above, the subjective noise is obtainable by subjective experiments, and the subjective noise quantity is changed according to the subject scene data, area and luminance. The three graphs shown in FIG. 5 show relations between the subjective noise quantity M and the average value X in the case with subjective scene data of i and area of S1, the case with subject scene data of i and area of S2 and the case with subject scene data of j and area of S1.

The noise calculating part 618 calculates the subjective noise quantity in noted pixels by calculating the subjective noise quantity by using the average value X of the local area transferred from the subject scene data calculating part 617 and multiplying the calculated subjective noise quantity by the amplification factor obtained from the gain calculating part 616. The part 618 transfers calculated subjective noise quantity and the subject scene data in each pixel to the subjective noise reducing part 7. The subjective noise quantity is presumed to be the subjective noise quantity of the center pixel of the area extracted in the local area extracting part 614. The control unit 8 controls the local area extracting part 614 to calculate the above subjective noise quantity with respect to all pixels of other labels than “0”.

In the example shown in FIG. 2, the particular color extracting unit 611 extracts a particular color in the signal, the image area dividing part 612 extracts an area having a certain size in the image, the subject scene recognizing part 613 recognizes subject scene data, and the noise calculating part 618 estimates the subjective noise. That is, a particular color area is extracted from the image signal, a subject scene is estimated from the extracted particular color area, then the subjective noise is calculated, and the subject scene is estimated by using the particular color data. Thus, it is possible to estimate sky, skin, green, etc. highly accurately.

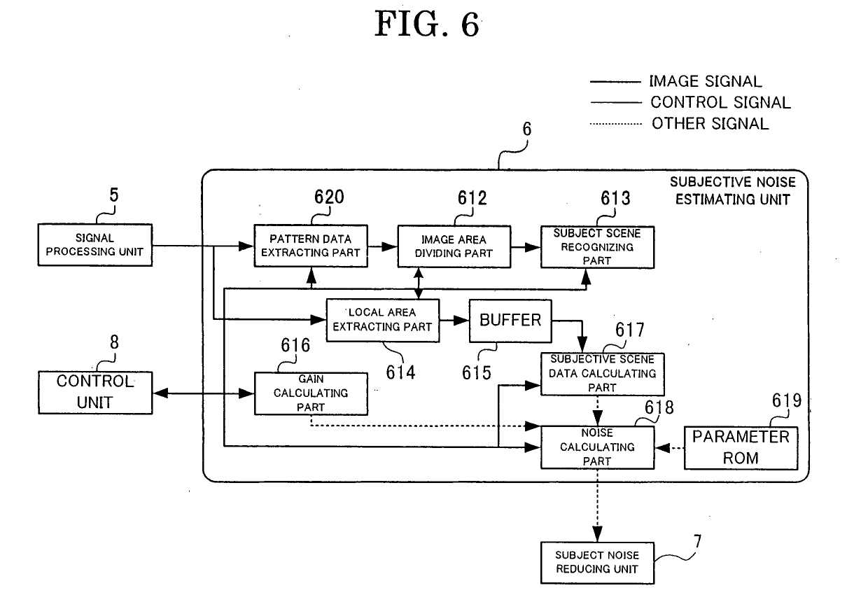

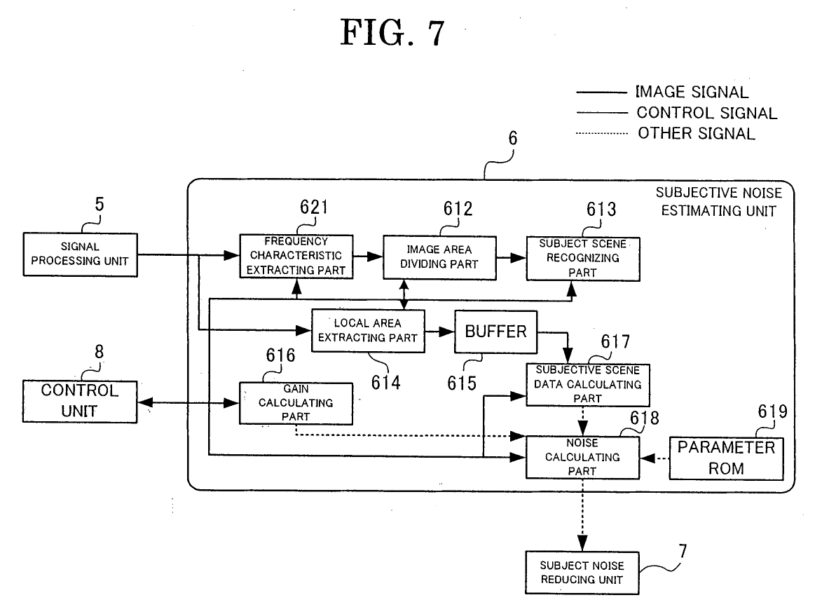

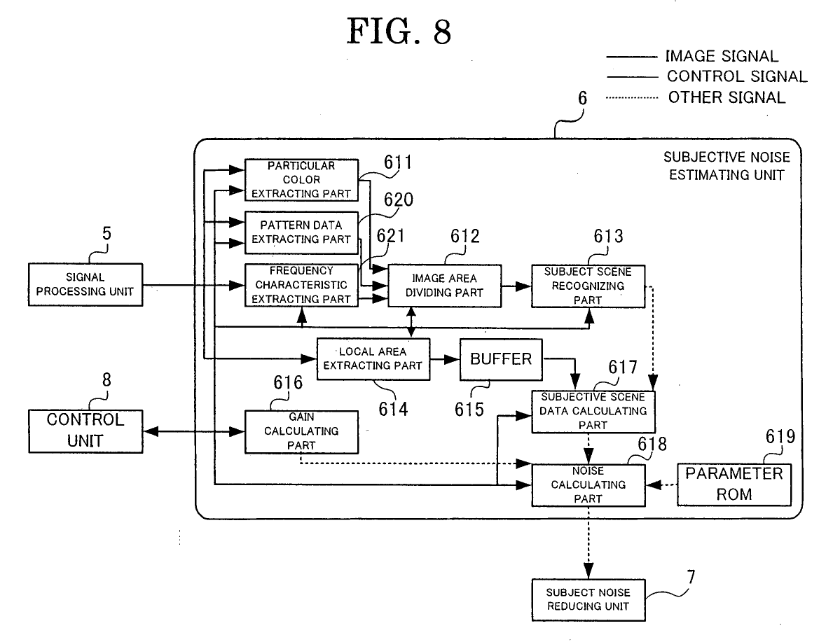

FIGS. 6 to 8 are block diagrams showing a second to a third example, respectively, of the subjective noise estimating part 6. In the examples shown in FIGS. 6 and 7, a data extracting part 620 and a frequency characteristic extracting part 621, respectively, are substituted for the particular color extracting part 611 shown in FIG. 2. In the example shown in FIG. 8, a pattern data extracting part 620 and a frequency characteristic extracting part 621 are provided in addition to the particular color extracting part 611 shown in FIG. 2.

The examples shown in FIGS. 6 to 8 are the same in the basic arrangement as the example shown in FIG. 2, and same parts are given same names and same numerals. Also, these examples are basically the same in the signal flow as the example shown in FIG. 2, and only different parts will be described.

First, the example shown in FIG. 6 will be described. Under control of the control unit 8, the pattern data extracting part 620 reads out only predetermined area centered on noted pixels in the video image transferred from the signal processing unit 5, and executes a well-known pattern matching process on the read-out predetermined area with respect to preliminarily prepared patterns of a face, sky, trees, etc. After it has executed the pattern matching process on all the pixels, the part 620 maps, in actual space, pixels recognized as pattern of a face, sky, trees, etc.

Subsequently, as shown in FIG. 3(b), under control of the control unit 8 the image area dividing part 613 recognizes the subject scene extracted in the image area dividing part 612. The part 613 recognizes the subject scene as shown in FIG. 4 as described above.

In the case of a subject scene present in an area a10 or all and having a pattern of sky, the subject scene recognizing part 613 recognizes the scene to be sky. In the case of a scene present in an area a12 or a13 and having a pattern of sea, the part 613 recognizes the scene to be sea. In the case of a scene present in an area a4, a6 or a7 and having a pattern of a face, the part 613 recognizes the scene to be a face. In the case of a scene present in an area a4, a6, a7, a10 or all, and having a pattern of trees, the part 613 recognizes the scene to be trees. In the case of a subject scene present in an area a5, a8, a9, a12 or a13 and having a pattern of a turf, the part 613 recognizes the scene to be a turf.

As a result of the process, the subject scene recognizing part 613 labels all the pixels extracted as subject scene in such a manner that a scene of sky is “1” and a scene of a face is “2”. In the process from the pattern data extracting part 620 to the subject scene recognizing part 613, the unit 613 labels the pixels which have failed to be recognized to be any subject scene to be “0”. In this way, the part 613 labels all the pixels, and transfers the labeled pixel data to the subject scene data calculating part 617. The subsequent process is the same as in the example shown in FIG. 2.

As described above, in the example shown in FIG. 6, the pattern data extracting part 620 extracts pattern data in the signal, the image area dividing part 612 extracts an area having a certain size in the image, the subject scene recognizing part 613 recognizes the subject scene data, and the noise calculating part 618 estimates the subjective noise. That is, the pattern data is extracted from the image signal, the subject scene is estimated from the extracted pattern data, then the subjective noise is calculated, and then the subject scene is estimated by using the pattern data. Thus, it is possible to estimate subject scenes based on patterns highly accurately.

Now, the example shown in FIG. 7 will be described. Under control of the control unit 8 the frequency character extracting part 621 reads out image signal transferred from the signal processing unit 5, and executes a well-known Fourier transform process for frequency transform. The frequency band is then divided into some frequency ranges or groups from low to high frequencies, and image signals grouped in the frequency space are mapped in the actual space.

Subsequently, as shown in FIG. 3(b), in the actual space the image area dividing part 612 extracts an aggregate of pixels having a predetermined area as subject scene. Under control by the control unit 8, the subject scene recognizing part 613 recognizes the subject scene extracted in the image area dividing part 612. The part 613 recognizes the subject scene as shown in FIG. 4. In the case of a subject scene present in an area a10 or all and at a low frequency, the part 613 recognizes the scene to be sky. In the case of a scene present in an area a4, a6 or a7 and at a low frequency, the part 613 recognizes the scene to be a face. In the case of a scene present in an area a4, a6, a7, a10 and all and at a high frequency, the part 613 recognizes the scene to be a tree.

As a result of this process, the subject scene recognizing part 613 labels all the pixels extracted as subject scene in such a manner that a scene pattern of sky is “1” and a scene pattern of a face is “2”. In the process executed in the frequency characteristic extracting part 621 up to the subject scene recognizing part 613, the pixels which have not been recognized as any subject scene are labeled to be “0”. Thus, the part 613 labels all the pixels, and transfers the labeled pixel data to the subject scene data calculating part 617. The subsequent process is the same as in the example shown in FIG. 2.

As described above, in the example shown in FIG. 7, the frequency characteristic extracting part 621 extracts the frequency characteristic of the signal, the image area dividing part 612 extracts areas having a certain size in the image, the subject scene recognizing part 613 recognizes the subject scene data, and the noise calculating part 618 estimates the subjective noise. That is, the frequency characteristic is extracted from the image signal, the subject scene is estimated from the extracted frequency characteristic, then the subjective noise is calculated, and then the subject scene is estimated by using the frequency characteristic. Thus, it is possible to estimate subject scenes from frequencies highly accurately.

Now, the example shown in FIG. 8 will be described. Under control of the control unit 8, the particular color extracting part 611, the pattern data extracting unit 620 and the particular characteristic extracting part 621 operate together to extract particular color, pattern data and frequency characteristic by the method described above by using the image signal transferred from the signal processing unit 5.

Under control of the control unit 8, the image area dividing part 612 maps, in the actual space, spots extracted as particular colors, spots extracted as patterns of a face, sky, trees, etc. and spots each extracted for each frequency band. After execution of this process on the image signal, the part 612 extracts, as subject scene in the actual space, the aggregate of pixels, in which three different kinds of data, i.e., the particular color, pattern data and frequency band, are commonly present and which have an area of at least a certain size.

Under control of the control unit 8, the subject scene recognizing part 613 recognizes the subject scene extracted in the image area dividing part 612. The part 613 recognizes the subject scene by using the above FIG. 4.

In the case of a subject scene present in an area a10 or all, blue in color, having a scene pattern of sky and at a low frequency, the subject scene recognizing part 613 recognizes the scene to be sky. In the case of a scene present in an area a12 or a13, blue in color, having a scene pattern of sea and at a high frequency, the part 613 recognizes the scene to be sea. In the case of a scene present in an area a4, a6 or a7, skin in color, having a scene pattern of a face and at a low frequency, the part 613 recognizes the scene to be a face. In the case of a scene present in an area a4, a6, a7, a10 and all, green in color, having a scene pattern of trees and at a high frequency, the part 613 recognizes the scene to be a tree. In the case of a scene present in an area a5, a8, a9, a12 or a13, green in color, having a scene pattern of turf and at a low frequency, the part 613 recognizes the scene to be turf.

As a result of the process, the part 613 labels all the pixels extracted as subject scene in such a manner that the scene is “1” when it is sky and “2” when it is a face. The part 613 decides the pixels failed to be recognizes as subject scene in the above process to be of label “0”. In this way, the part 613 labels all the pixels, and transfers the labeled pixel data to the subject scene data calculating part 617. The subsequent process is the same as in the example shown in FIG. 2.

As described above, in the example shown in FIG. 8, the particular color extracting part 611, the pattern data extracting part 620 and the frequency characteristic extracting part 621 together operate to extract the feature quantity in the signal, the image area dividing part 612 extracts areas having a certain size in the image, the subject scene recognizing part 613 recognizes the subject scene data, and the noise calculating part 618 estimates the subjective noise. That is, particular color data, pattern data and frequency characteristic are extracted from the image signal, the subject scene is estimated from the extracted data, then the subjective noise is calculated, and then the subject scene is estimated by using a plurality of pieces of data obtained from the image signal. Thus, it is possible to estimate the subject scene highly accurately.

FIG. 9 is a block diagram showing an example of the subjective noise reducing unit 7. The subjective noise reducing unit 7 includes a local area extracting part 711, a buffer 712, a smoothing part 713, a gain calculating part 714, a filter calculating part 716, and a filter coefficient ROM 715.

Under control of the control part 8, the gain calculating part 714 obtains the gain amplification factor obtained in a process in the preprocessing unit 3 according to the ISO sensitivity set via the external I/F unit 9, and transfers the obtained gain amplification factor 716 to the filter calculating unit 716. Under control of the control unit 8, the filter calculating part 716 reads out a coefficient used in a filter process from the filter coefficient ROM 715 according to subject scene data transferred from the subjective noise estimating part 6. The above process is executed for each label. Then, the control unit 8 controls the local area extracting part 711 to extract areas of a predetermined size, for instance local areas in units of 5×5 pixels, centered on noted pixels and transfer the extracted area data to the buffer 712.

Under control of the control unit 8, the smoothing part 713 executes a well-known smoothing process with respect to the area of the buffer 712 by using gain and filter coefficient data transferred from the filter calculating part 716. The part 713 executes the smoothing process on the pixels of labels other than “0”. The control unit 8 controls the local area extracting part 711 to execute the filter process by moving a predetermined size area pixel by pixel in the horizontal and vertical directions.

With the above arrangement, the subjective noise is reduced as well as reducing noise in the imaging device. High quality images are thus obtainable. In addition, in the subjective noise estimation first classification is done by using the particular color and other data, and then the subject scene data is calculated. It is thus possible to estimate the subject scene highly accurately. Furthermore, the data concerning the noise quantity are stored in the form of functions. Thus, it is possible to reduce the capacity of the storing ROM and reduce cost. Moreover, the functions concerning the noise quantity are changed according to the subject scene data. Thus, it is possible to realize optimum subjective noise reduction according to the subject scene and obtain high quality images.

As described above, in the example shown in FIG. 9, the local area extracting part 711 extracts local areas centered on noted pixels in the signal, the filter calculating part 716 causes filter coefficient changes according to subject scene data, and the smoothing part 713 executes a smoothing process. That is, the smoothing process is executed by causing filter coefficient changes according to the subject scene data extracted from the image signal, and the filter coefficient is changed according to the subject scene data. Thus, it is possible to execute a subjectively preferred smoothing process.

The above example is based on hardware process as preamble, but such an arrangement is not limitative, for example, such an arrangement is possible as to cause output of the signal from the CCD 2 as non-processed raw data and of ISO sensitivity, image size and other data as header data and cause a separate software process.

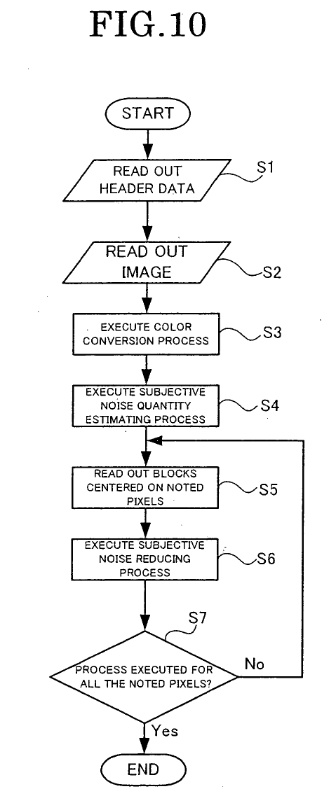

FIG. 10 shows a flow chart representing the software process routine in the first embodiment. In step S1 header data containing the ISO and image size data, and image is read out (step S2). Then, such signal processes as a white balance process and a color conversion process are executed (step S3). Then, a subjective noise quantity estimating process is executed (step S4). Then, blocks, for instance areas of 5×5 pixels, centered on noted pixels are read out (step S5). Then, a subjective noise reducing process is executed for each noted pixel unit (step S6). Then, a step S7 is executed, in which a check is made as to whether the process has been executed for all the noted pixels. When the process has been executed for all the noted pixels, an end is brought to the routine.

As the CCD in the embodiment, it is possible to use CMOS or the like as well as primary color single plate CCD, complementary color single filter CCD and two- or three-filter CCD. The subjective noise quantity calculation has been executed with a method of operation with functions as a preamble, but this arrangement is not limitative. For example, the noise quantity maybe recorded as a table. In this case, it is possible to calculate the noise quantity highly accurately and at a high rate.

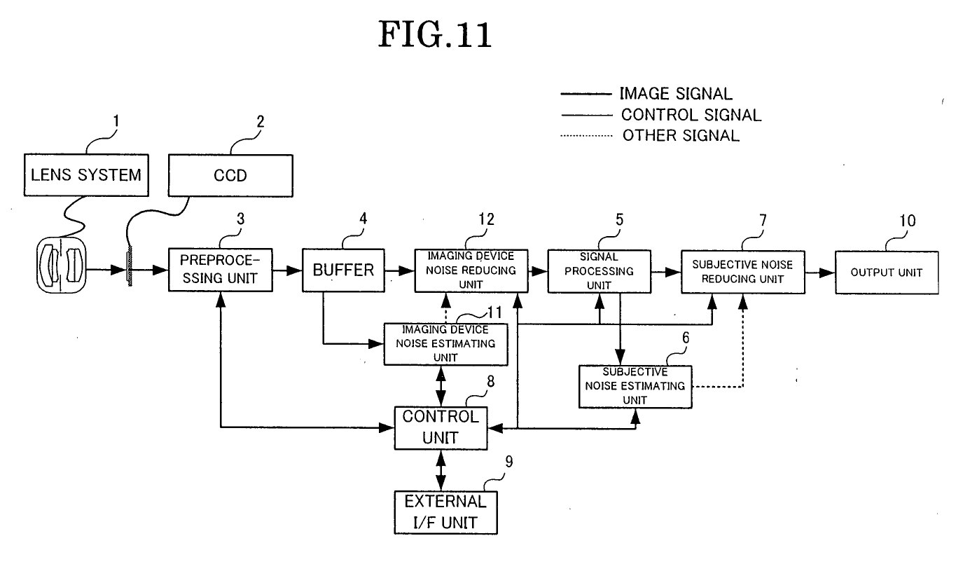

FIG. 11 is a block diagram showing a second embodiment of the imaging process system according to the present invention. Parts like those in the first embodiment are designated by same names and same reference numerals. The image signal obtained by imaging a subject scene via the lens system 1 and the CCD 2 and converting the scene data to electric signal, is fed to the preprocessing unit 3, which executes such processes as gain amplification, A/D conversion and AF and AE controls, for conversion to digital signal.

Under control of the control unit 8, the imaging device noise estimating unit 11 extracts areas of a predetermined size, for instance local areas in units of 5×5 pixels, centered on noted pixels from image signal outputted from the buffer 4, and estimates the imaging device noise quantity. The estimated imaging device noise quantity is transferred to the imaging device noise reducing unit 12. The imaging device noise estimating unit 11 calculates a standard deviation as noise quantity of the local area, and transfers the calculated standard deviation to the imaging device noise reducing unit 12.

Under control by the control unit 8, the imaging device noise reducing unit 12 executes an imaging device noise reducing process in the local area. The unit 12 compares the standard deviation of the local area transferred from the imaging device noise estimating unit 11 and the estimated imaging device noise quantity. When the part 12 finds that the standard deviation of the local area is smaller than the estimated imaging device noise quantity, it executes a well-known smoothing process in the local area, thus updating the value of the noted pixels. When the unit 12 finds that the standard deviation of the local area is greater than the estimated imaging device noise quantity, it executes no process.

The imaging device noise reducing unit 12 executes the imaging device noise reducing process on all the pixels, and it transfers image signal obtained in this process to the signal processing part 5. Under control of the control unit 8, the signal processing unit 5 executes such well-known processes as white balance and color conversion processes, and transfers the result data to the subjective noise estimating part 6 and the subjective noise reducing part 7.

Under control of the control unit 8, the subjective noise estimating part 6 executes subjective noise estimation by extracting local areas centered on noted pixels from the image signal after the imaging device noise reduction. Like the imaging device noise estimating unit 11 described above, the unit 6 transfers the estimated subjective noise quantity and the standard deviation of the local area to the subjective noise reducing unit 7.

Under control of the control unit 8, the subjective noise reducing unit 7.executes the subjective noise reducing process in the local area. The unit executes the subjective noise reducing process on all the noted pixels, and transfers image signal after the subjective noise reduction to the output unit 10. In the output unit 10, the image signal is recorded and stored in a memory card or the like.

As described above, in the embodiment shown in FIG. 11, the imaging device noise estimating unit 11 estimates the imaging unit noise, the imaging device noise reducing unit 12 reduces the imaging device noise, the subjective noise estimating unit 6 estimates the subjective noise, and the subjective noise reducing unit 7 reduces the subjective noise of the image. Thus, not only the imaging device noise but also the subjective noise is reduced, and it is thus possible to obtain subjectively preferred high quality images.

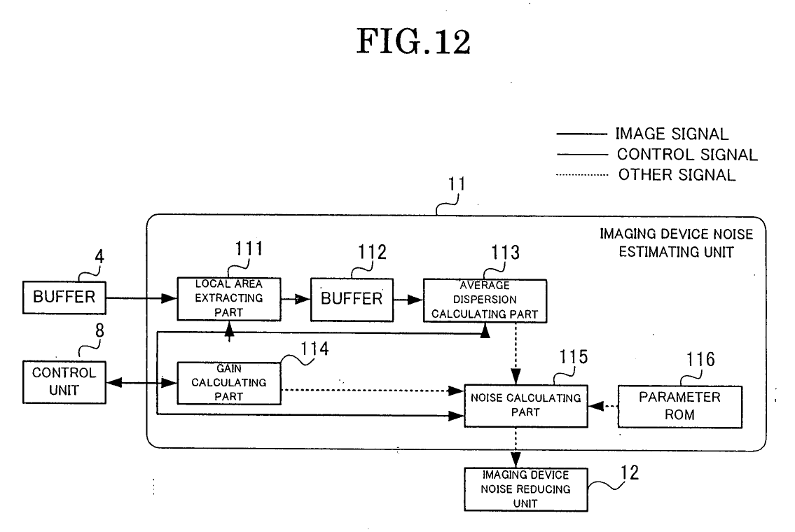

FIG. 12 shows an arrangement example of the imaging device noise estimating unit 11. The imaging device estimating unit 11 includes a local area extracting part 111, a buffer 112, an average variance calculating part 113, a gain calculating part 114, a noise calculating part 115 and a parameter ROM 116.

Under control of the control unit 8, the gain calculating part 114 obtains the gain amplification factor in the processing unit 3 according to ISO sensitivity provided via the external I/F part 9, and transfers the obtained amplification factor to the noise calculating part 115. In this example, it is assumed that the ISO sensitivity is in three stages 100, 200 and 400, and the amplification factors therefor are set to be “1”, “2” and “4”, respectively,

Under control of the control unit 8, the noise calculating part 115 obtains function data used for the imaging device noise calculation from the parameter ROM 116 according to the amplification factor from the gain calculating part 114.

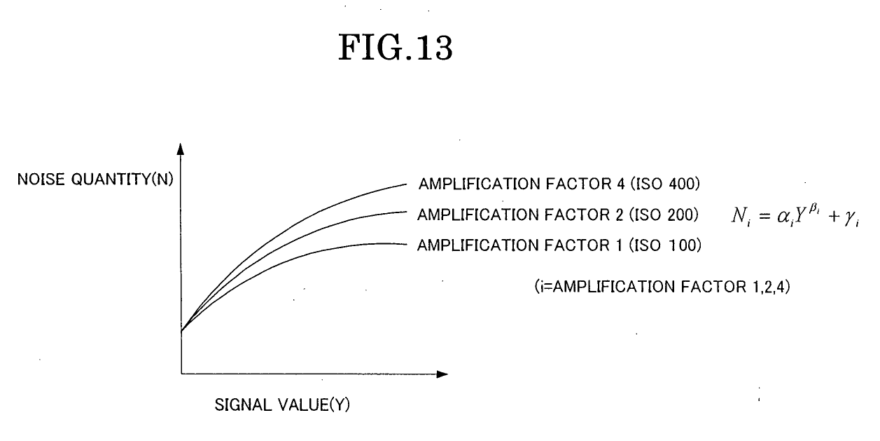

FIG. 13 is a view for describing the function data recorded in the parameter ROM 116 for use for imaging device noise quantity calculation. Imaging device noise quantity N increases as powers of signal value Y. A function model expression of this is as in equation (1).
N=αY^{β}+γ (1)
where α, β and γ are constants. The imaging device noise quantity is changed according to the amplification factor in a gain process in the preprocessing unit 3. The three graphs shown in FIG. 13 represent relations between the imaging device noise quantity N and the signal value Y concerning the three ISO sensitivity stages 100, 200 and 400, respectively. By expanding the equation (1) with differences based on the amplification factors taken into consideration, we have equation (2).
Nᵢ=αᵢY^{βi}+γᵢ (2)
where i is a parameter representing the amplification factor and 1, 2 and 4 in this example. Constant terms of αᵢ, βᵢ and γᵢ are recorded in the parameter ROM 116.

The noise calculating part 115 reads out the above constant terms of α, βᵢ and γᵢ from the parameter ROM 116. The part 115 executes the above process only once with respect to a single image signal.

The control unit 8 then controls the local area extracting part 111 to extract areas of a predetermined size, for instance local areas in units of 5×5 pixels, centered on noted pixels from the image signal in the buffer 4, and transfers the read-out area data to the buffer 112.

Under control of the control unit 8, the average variance calculating part 113 calculates the average value and variance (i.e., standard deviation) concerning the area in the buffer 112. The part 113 transfers these values to the noise calculating part 115.

The noise calculating part 115 calculates the imaging device noise quantity from the transferred average value Y by using the equation (2), and transfers the calculated imaging device noise quantity data to the imaging device noise reducing unit 12. The part 115 also transfers the variance (i.e., standard deviation) calculated as noise quantity in the noise calculating unit 115 to the imaging device noise reducing unit 12. The above imaging device noise quantity is presumed to be imaging device noise quantity of center pixels in areas extracted in the local area extracting part 111. The control unit 8 controls the local area extracting part 111 to calculate the imaging device noise quantity from the entire image signal by moving a predetermined size area pixel by pixel in the horizontal and vertical directions.

While in the above embodiment the hardware process is a preamble, such an arrangement is by no means limitative; for example, such an arrangement is possible as to cause output of the signal from the CCD 2 as non-processed raw data and of ISO sensitivity and image size data as header data to be processed separately on software.

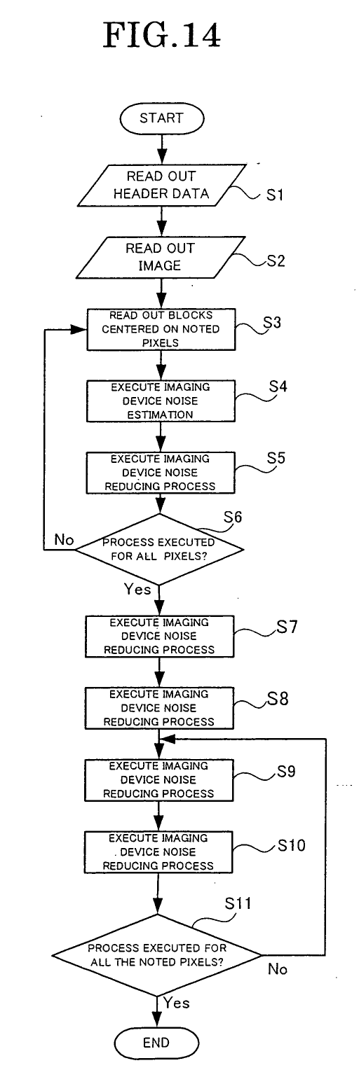

FIG. 14 is a flow chart showing the software process routine in the second embodiment. In step S1 header data containing the IOS sensitivity and image size data is read out, and the image is read out (step S2). Then, blocks, for instance areas of 5×5 pixels, centered on noted pixels are read out (step S3), and imaging device noise estimation is executed for each noted pixel unit (step S4), and an imaging device noise reducing process is executed for each noted pixel unit (step S5). Subsequently, a check is made as to whether the process has been made on all the pixels (step S6). When the process has been made on all the pixels, a step S7 is executed, in which such processes as white balance and color conversion processes are made (step S8). Then, blocks, for instance areas of 5×5 pixels, centered on noted pixels are read out (step S9), and a subjective noise reducing process is executed for each noted pixel unit (step S10). Then, check is made as to whether the process has been executed for all the pixels (step S1). When the process has been made for all the pixels, an end is brought to the routine.

As the CCD in the embodiment, CMOS or the like is conceivable as well as primary color single filter CCD, complementary color single filter CCD and two- or three-filter CCD. While in the above embodiment the calculation of the imaging device noise quantity is executed with the method of forming functions as a preamble, such an arrangement is by no means limitative; for instance such an arrangement is possible as to record the noise quantity as a table. In this case, it is possible to calculate the noise quantity highly accurately and at a high rate.

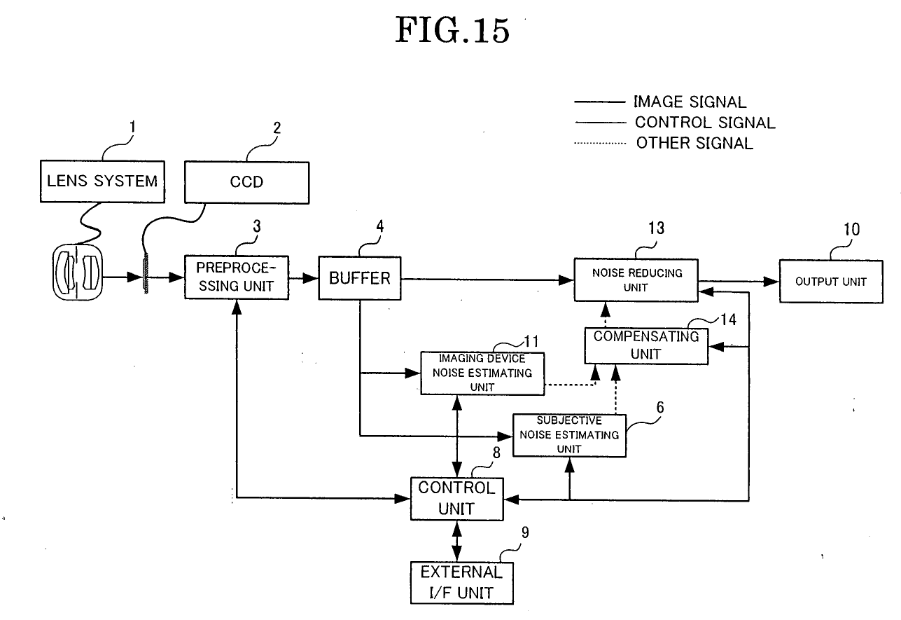

FIG. 15 is a block diagram showing a third embodiment of the imaging process system according to the present invention. Parts like those in the first embodiment are designated by same names and reference numerals. Only parts different from the first embodiment will be described.

The image signal obtained by imaging a subject scene via the lens system 1 and the CCD 2 are fed to the processing unit 3, which executes such processes as gain amplification, A/D conversion and AF and AE controls, for conversion to digital signal.

Referring to FIG. 15, after imaging conditions such as ISO sensitivity have been set via the external I/F unit 9, the image signal is taken by pushing a shutter button. Under control of the control unit 8, the imaging device noise estimating unit 11 and the subjective noise estimating unit 6 operate together to extract areas of a predetermined size, for instance areas in units of 5×5 pixels, centered on noted pixels and estimates the noise quantity of each extracted area.

The imaging device noise estimating unit 11 estimates the standard deviations of the local areas and the imaging device noise quantity, and transfers the estimated data to the compensating unit 14.

The subjective noise estimating unit 6 estimates the subjective noise quantity by executing the same process as in the first embodiment, and transfers the estimated subjective noise quantity to the compensating unit 14. The compensating unit 14 calculates the gain for compensating for the transferred imaging device noise quantity according to the noise quantity from the subjective noise estimating unit 6, and executes compensation for the imaging device noise quantity according to the calculated gain. The unit 6 transfers the compensated noise quantity to the noise reducing unit 13. Alternately, the unit 14 compares the transferred imaging device noise quantity and the subjective noise quantity, and transfers the greater value noise quantity to the noise reducing unit 13.

Under control of the control unit 8, the noise reducing unit 13 executes the noise reducing process in a local area. The unit 13 then compares the standard deviation of the local area transferred from the imaging element noise estimating unit 11 and the noise quantity transferred from the compensating unit 14. When the unit 13 finds that the standard deviation of the local area is less than the noise quantity, it executes a well-known smoothing process in the local area to update the values of the noted pixels. When the unit 13 finds that the standard deviation of the local area is less than the estimated imaging device noise quantity, it executes no process.

The processes in the imaging device noise estimating unit 11, the subjective noise estimating unit 6 and the compensating unit 14 are executed under control of the control unit 8 in synchronism to the process in the noise reducing unit 13. The noise reducing process is executed on all the pixels, and the image signal of the noise reduction is transferred to the output unit 10. In the output unit 10, the image signal is recorded and stored in a memory card or the like.

As described above, in the embodiment of the imaging process system shown in FIG. 15, the imaging device noise estimating unit 11 estimates the noise of the imaging device, the subjective noise estimating unit 6 estimates the subjective noise, the compensating unit 14 executes the noise quantity compensation by using the above two different noise quantities, and the noise reducing unit 13 reduces the noise reduction of the signal. That is, the noise reducing process is executed by estimating the imaging device noise quantity and executing the compensation thereof according to the condition of the subject scene. Thus, the compensation is executed according to the condition of the subject scene, and it is possible to obtain subjectively preferred, high quality images.

In the imaging process system shown in FIG. 15, the compensating unit 14 compares the imaging device noise and the subjective noise and uses either one of these noise quantities. That is, as a result of comparison of the imaging device noise and the subjective noise, either one of the noise quantities is used, and the process thus can be executed more quickly.

While in the above embodiment the hardware process is a preamble, such an arrangement is by no means limitative; for example such as arrangement is possible as to cause output of the signal from the CCD 2 as non-processed raw data and the ISO sensitivity and image size data as header data for a separate software process.

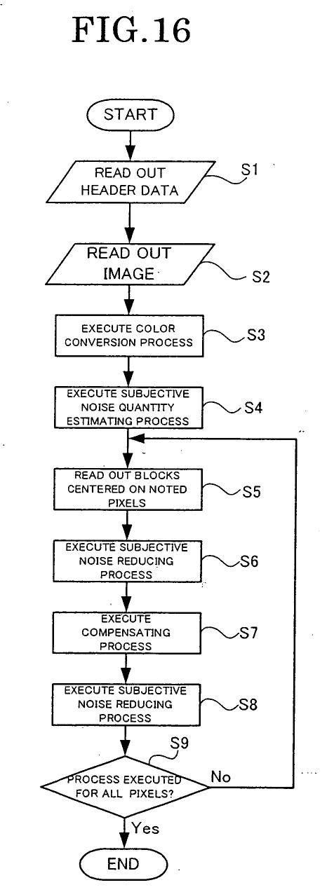

FIG. 16 is a flow chart showing a software process routine in the third embodiment. In a step S1, header data including ISO sensitivity and image size data are read out, and the mage is read out (step S2). Then, such preprocesses as color conversion are executed (step S3), the subjective noise estimation is executed (step S4), blocks, for instance areas of 5×5 pixels, centered on noted pixels are read out (step S5). Subsequently, the imaging device noise estimation is executed for each noted pixel unit (step S6). Then, a compensating process is executed according to the estimated imaging device noise quantity and the subjective noise quantity (step S7). Then, a noise reducing process is executed for each noted pixel (step S8). Then, a step S8 is executed, in which a check is made as to whether the process has been executed for all the pixels. When the process has been executed for all the pixels, an end is brought to the routine.

With the above arrangement, the noise quantity is compensated according to the subject scene data such as to obtain subjectively preferred images, and only signals with less than the compensated noise quantity are subjected to the smoothing process. It is thus possible to execute noise reducing process, which is highly accurate and subjectively preferred.

According to the present invention, at least the following particularly pronounced effects are obtainable.

(1) It is possible to obtain subjectively preferred, high quality images.

(2) It is possible to obtain subjectively preferred, high quality images by reducing not only imaging device noise but also subjective noise.

(3) Since compensation is executed according to the subject scene condition, it is possible to obtain subjectively preferred, high quality images.

(4) Since the subject scene is by using particular color data, it is possible to estimate, sky, skin, green, etc. highly accurately.

(5) Since the subject scene is assumed by using pattern data, it is possible to estimate subject scenes based on patterns highly accurately.

(6) Since the subject scene is estimated by using the frequency characteristic, it is possible to estimate subject scenes based on frequencies highly accurately.

(7) Since the subject scene is estimated by using a plurality of pieces of data obtained from image signal, it is possible to estimate subject scenes highly accurately.

(8) Since the filter coefficient is changed according to the subject scene data, it is possible to obtain a subjectively preferred smoothing process.

(9) Since the imaging device noise and the subjective noise are compared and either one of the noise quantities is used, it is possible to realize process execution at a higher rate.

1. An imaging process system for obtaining subject scene data of a predetermined subject from a image signal constituted by pixel signals obtained from an imaging device and reducing noise contained in image signal according to the obtained subject scene data.

2. An imaging process system for obtaining subject scene data of a predetermined subject from a image signal constituted by pixel signals obtained from an imaging device and reducing noise contained in the image signal according to the obtained subject scene data, while estimating imaging device noise caused by the imaging device from the image signal and reducing the imaging device noise according to the estimated imaging device noise.

3. The imaging process system according to claim 1, wherein predetermined subjective noise contained in the subject scene image signal is estimated according to the subject scene image, and the noise reducing process is executed according to the estimated noise.

4. The imaging process system according to claim 1, wherein the subject scene data is obtained according to a local area signal as a small aggregate of pixel signals.

5. The imaging process system according to claim 3, wherein a standard deviation of the local area is obtained, and the noise reducing process is executed according to the obtained standard deviation and the subjective noise.

6. The imaging process system according to claim 5, wherein a smoothing process is executed when a standard deviation of the local area is less than the estimated subjective noise quantity.

7. The imaging process system according to claim 3, wherein in the subjective noise estimation the pixel signals are sorted according to predetermined colors, and the subject scene data is obtained according to sorted areas.

8. The imaging process system according to claim 3, wherein the relationship of area data and average value of the subject scene data and subjective noise quantity is preliminarily stored in a ROM, the subjective noise is obtained with reference to the ROM according to the obtained area data and the average value of the subject scene.

9. The imaging process system according to claim 1, wherein the subject scene data is obtained in a pattern matching process of comparing a preliminarily prepared pattern of pixel signals for a predetermined area and a pattern of the pixel signals obtained from the image signal for a predetermined area.

10. The imaging process system according to claim 1, wherein frequency data of the image signal is obtained, and the subject scene data is obtained according to the frequency data.

11. The imaging process system according to claim 1, wherein parameters for a filtering process for executing the noise reducing process is preliminarily stored, and the filtering process is executed with parameters read out from the ROM according to the subject scene data.

12. The imaging process system according to claim 2, wherein the imaging device noise reducing process is executed prior to the subjective noise reducing process.

13. An imaging process system for estimating imaging device noise caused by the imaging device from a image signal constituted by pixel signals obtained from the imaging device, estimating predetermined subjective noise from the image signal, compensating for imaging device noise according to the estimated subjective noise and reducing the image signal noise according to the compensated noise.

14. An imaging process method comprising:
a first step of inputting header data containing ISO sensitivity and image size data and an image signal constituted by pixel signals from an imaging device;
a second step of executing a white balance process, a color conversion process, etc. on the image signal;
a third step of estimating a predetermined subjective noise quantity according to an image signal obtained after the process in the second step; and
a fourth step of executing a subjective noise reducing process according to the estimated subjective noise quantity.

15. An imaging process method comprising:
a first step of inputting header data containing ISO sensitivity and image size data and an image signal constituted by pixel signals from an imaging device;
a second step of reading out an mage signal of predetermined areas centered on noted pixels;
a third step of estimating imaging device noise for each noted pixel unit;
a fourth step of executing an imaging device noise reducing process according to the estimated imaging device noise for each noted pixel unit;
a fifth step of executing the processes of the above steps on all pixels;
a sixth step of executing a white balance process, a color conversion process, etc. after the first to fifth steps on all the pixels;
a seventh step of estimating predetermined subjective noise on the image signal; and
an eighth step of executing a subjective noise reducing process for each noted pixel unit according to the estimated subjective noise.

16. An imaging process system for reducing noise contained in a digitalized image signal from an imaging device, comprising:
a subjective noise estimating means for estimating a predetermined noise quantity in the signal; and
a subjective noise reducing means for reducing subjective noise in the signal according to the subjective noise quantity.

17. An imaging process system for reducing noise contained in a digitalized image signal from an imaging device, comprising:
an imaging device noise estimating means for estimating an imaging device noise quantity in the signal;
an imaging device noise reducing means for reducing imaging device noise in the signal according to the imaging device noise quantity;
a subjective noise estimating means for estimating predetermined subjective noise quantity of a subject scene in the signal; and
a subjective noise reducing means for reducing subjective noise in the signal according to the subjective noise quantity.

18. An imaging process system for reducing noise contained in a digitalized image signal from an imaging device, comprising:
an imaging device estimating means for estimating an imaging device noise quantity in the signal;
a subjective noise estimating means for estimating a predetermined subjective noise quantity of a subject scene in the signal;
a compensating means for compensating for the imaging device noise quantity according to data obtained from the subjective noise estimating means; and
a noise reducing means for noise in the signal according to the compensated noise quantity.

19. An imaging process system according to claim 16, wherein the subjective noise estimating means includes:
a particular color extracting means for extracting a particular color in the signal;
an image dividing means for dividing the image according to the particular color data;
a subject scene recognizing means for recognizing subject scene data of the area divisions; and
a subjective noise calculating means for estimating subjective noise quantity of the subject scene in the signal.

20. The imaging process system according to claim 16, wherein the subjective noise estimating means includes:
a pattern data calculating means for calculating pattern data in the signal;
an image dividing means for dividing image according to the pattern data;
a subject scene recognizing means for recognizing subject scene data of the area divisions; and
a subjective noise calculating means for estimating a subjective noise quantity of subject scene in the image.

21. The imaging process system according to claim 16, wherein the subjective noise estimating means includes;
a frequency characteristic calculating means for calculating the frequency characteristic of the signal;
an image dividing means for dividing image according to the frequency characteristic;
a subject scene recognizing means for recognizing subject scene data of the area divisions; and
a subjective noise calculating means for estimating a subjective noise quantity of subject scene in the signal.

22. The imaging process system according to claim 16, wherein the subjective noise estimating means includes:
a feature quantity calculating means for calculating at least two among particular color pattern data and frequency characteristic of the signal;
an image dividing means for dividing image according to the feature calculated in the feature calculating means;
a subject scene recognizing means for recognizing subject scene data of the area divisions; and
a subjective noise calculating means for estimating subjective noise quantity of subject scene in the signal.

23. The imaging process system according to claim 16, wherein the subjective noise reducing means includes:
a local area extracting means for extracting local areas of noted pixels in the signal;
a filter calculating means for changing filter coefficient according to subject scene data from the subject scene means;
a filter calculating means for changing filter coefficient according to subject scene from the subject scene recognizing means; and
a smoothing means for executing a filter process with respect to the local areas by using a filter obtained from the filter calculating means.

24. The imaging process system according to claim 18, wherein the compensating means includes:
a comparing means for comparing an imaging device noise quantity estimated in the imaging device noise estimating means with respect to a noted pixel in the signal and a subjective noise quantity estimated in the subjective noise estimating means and using either one of the compared noise quantities.

25. A computer program for executing the processes according to claim 1.

26. A storing medium, in which the computer program according to claim 25 is stored.
